(19) United States
(12) Patent Application Publication
(10) Pub. No.: US 2013/0070907 A1
(43) Pub. Date: Mar. 21, 2013

(54) X-RAY DEVICE

(71) Applicant: Oliver Hornung, Furth (DE)

(72) Inventor: Oliver Hornung, Furth (DE)

(21) Appl. No.: 13/425,344

(22) Filed: Mar. 20, 2012

(30) Foreign Application Priority Data
Mar. 21, 2011 (DE) DE 102011005847.8

(51) Int. Cl. H05G 1/02

(52) U.S. Cl. CPC H05G 1/02
USPC 378/197

(57) ABSTRACT

The present embodiments relate to an x-ray device that includes at least one x-ray emitter and a recording system provided to detect x-ray radiation as separately displaceable x-ray components of the x-ray device. Two arms, each at least indirectly supporting an x-ray component, may be positioned in a ring structure. The ring structure is formed with the aid of a suitable shoulder joint construction supporting the two arms, such that the two arms are largely supported orthogonally to one another and may rotate about a common rotation axis.

This application claims the benefit of DE 10 2011 005 847.8, filed on Mar. 21, 2011.

### BACKGROUND

The present embodiments relate to an x-ray device.

Angiography applications have an important place in intraoperative imaging. Modern 3D image reconstruction procedures are gaining in significance alongside the conventional tasks of angiography modalities (e.g., vessel imaging using statically but flexibly positionable recording systems). To generate the required data, image sequences are recorded over precisely defined paths of the image recording system. These techniques may already be deployed within limits using existing modalities (e.g., DynaCT, SpiralCT).

C-arm x-ray devices represent a widely used model of the x-ray devices used in angiography. A C-arm supporting an x-ray source and an associated detector may be pivotably attached in a movable fashion to a displaceable unit (e.g., see FIG. 3). A C-arm of an x-ray device may be moved on a buckling arm robot. The robot arm allows the x-ray source and the x-ray detector to move on a defined path around the patient.

While C-arm x-ray devices are designed primarily for the flexible but static acquisition of projection recordings, computed tomography devices operating with x-ray radiation sources traveling along an orbital ring about an axis of rotation are used to generate sectional image recordings. In certain areas, computed tomography devices may be replaced by C-arm x-ray devices with an extended functional scope. These C-arm x-ray devices may also generate sectional images. Sectional images are generated from image sequences obtained using a recording system that may be displaced along a trajectory. The reconstruction quality is not as good as may be achieved using a computed tomography device. Also, the image recording system may not be rotated completely.

This is because very high rotation speeds of the image recording system are attained with the CT device. Reconstruction artifacts that result due to the movement of the patient or organs (e.g., heart) during a recording are thus reduced to a minimum. The fact that the system may be constructed in a very rigid fashion provides that the rotation is highly reproducible. This allows the initially measured circuit of beam focus and detector to be repeated very accurately, so that a very precise reconstruction is achieved by the stored projection matrices.

DynaCT and similar 3D reconstructions that may be performed using C-arms may be implemented with limited quality. To achieve a higher quality, 1) the rotation speed may be increased, and 2) the systems may be improved with respect to reproducibility.

This proposal cannot be achieved, however, with the currently available C-arm system structures.

### SUMMARY AND DESCRIPTION

Even if some angiography systems are already able to allow the C-arm to rotate at higher speeds, the open structure represents a considerable safety risk for patient and staff when the C-arm rotates faster than 90°/s (compared with CT: >1000°/s).

The C-arm structure of the prior art may be oscillation-prone. These unwanted oscillations are not fully reproducible. Since there is no actuator system present in the structure to allow active compensation for oscillations, extremely accurate reproducibility is difficult or impossible to achieve. Also, the system moving the C-arm only has limited repetition accuracy for each axis. With serial kinematics, these reproducibility errors accumulate in the worst case.

The present embodiments may obviate one or more of the drawbacks or limitations in the related art. For example, the abovementioned disadvantages may be overcome.

In one embodiment, an x-ray device has an x-ray emitter and an associated recording system (e.g., a flat-screen detector). The x-ray emitter and the recording system (e.g., x-ray components) are each supported directly or indirectly by at least one arm.

An appropriate shoulder joint construction may be used to position kinematic arms in a ring structure and anchor the kinematic arms in the ring structure with a defined form fit. If the ring itself is supported by a slip ring and driven in a rotary fashion according to the same approach as in DE 10 2008 032 294 A1 and the corresponding U.S. Pat. No. 7,988,357, which is hereby incorporated by reference, high rotation speeds may be attained if the system has a very high level of rigidity. Such speeds are not safety-critical, since the system is closed by the ring in the direction of the patient and staff. If free patient access is to provided, as in interventional imaging, for example, the arms move out of the ring structure and form the usual pattern of the system proposed in DE 10 2008 032 294 A1 with all the degrees of freedom of movement. One advantageous secondary effect of the proposed structure is the extreme compactness of the system in the retracted position.

One advantage is the possible attainment of high rotation speeds (like CT) with reproducibility of the circular movement with a system also suitable for interventional imaging due to its open structure. High 3D imaging quality combines with the advantages of the open C-arm structure.

### BRIEF DESCRIPTION OF THE DRAWINGS

FIG. 1 shows a front view of one embodiment of an x-ray device;

FIG. 2 shows a side view of one embodiment of an x-ray device; and

FIG. 3 shows a schematic view of a prior art x-ray device.

### DETAILED DESCRIPTION OF THE DRAWINGS

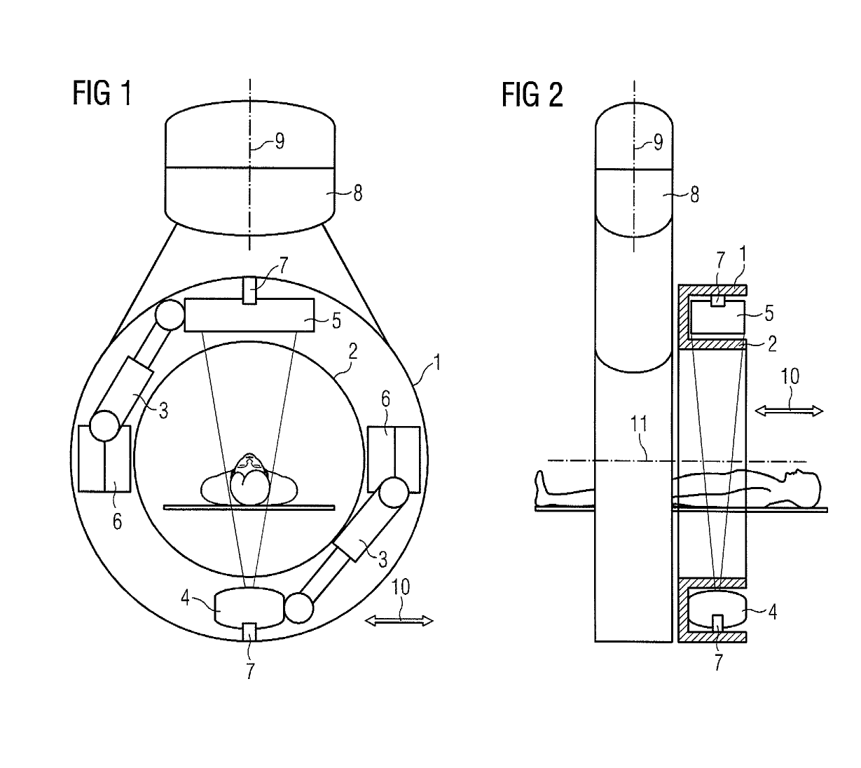

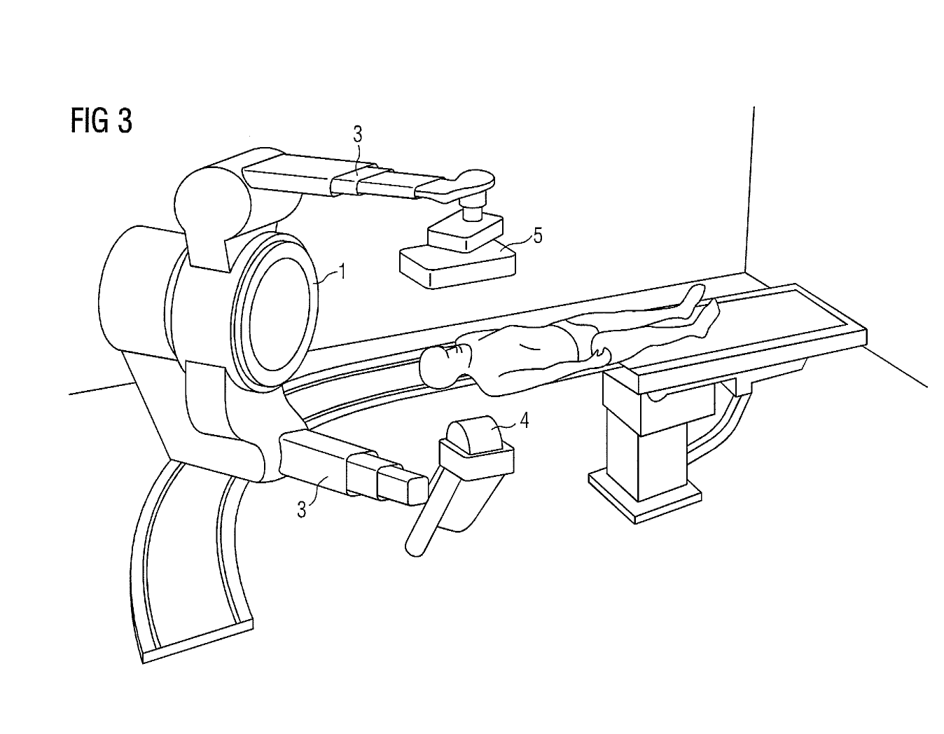

For an x-ray system (e.g., an x-ray device) having a a joint configuration (RRSRRR), the radius of a drum 1 is enlarged (FIG. 1) so that a ring structure 2, in which arms 3 that support an emitter 4 and a detector 5 (e.g., a flat-screen detector) are accommodated, results. The arms 3 may be configured to be adjustable lengthwise, so that the emitter 4 and the detector 5 may be positioned optimally in the ring structure 2. A joint 6 allows retraction movement. In the retracted configuration, a locking apparatus 7 secures a defined position of the emitter 4 and the detector 5. The system is connected to the ceiling by a stand 8 and one degree of rotational freedom 9 and may thus be moved in any direction above or adjacent to a table by way of a Cartesian ceiling suspension system (see reference character 10, for example, in FIG. 2). A first rotation axis 11 of the system from DE 10 2008 032 294 A1 may provide increased rotation speed in the retracted configuration. Where rotatability is unlimited, a transmission of energy and/or signals to the x-ray components may be made, for example, with the aid of slip rings. The abovementioned positioning of the arms 3, the emitter 4 and the detector 5 in the ring structure 2 may be controlled by a control unit (not shown).

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An x-ray device comprising:
an x-ray emitter that is displaceable by at least one first arm as a first x-ray component; and
a recording system that is displaceable independently of the x-ray emitter by at least one second arm as a second x-ray component,
wherein the at least one first arm and the at least one second arm, each at least indirectly supporting the first x-ray component or the second x-ray component, are positionable in a ring structure, the ring structure being formed with the aid of a shoulder joint construction supporting the at least one first arm and the at least one second arm, such that the at least one first arm and the at least one second arm are supported largely orthogonally to one another and are rotatable about a common rotation axis.

2. The x-ray device as claimed in claim 1, wherein the first x-ray component and the second x-ray component are positionable with the aid of the at least one first arm and the at least one second arm supporting the first x-ray component and the second x-ray component inside or outside the ring structure.

3. The x-ray device as claimed in claim 1, wherein the first x-ray component and the second x-ray component are anchored in the ring structure by a locking apparatus.

4. The x-ray device as claimed in claim 1, wherein the at least one first arm and the at least one second arm are configured to be adjustable lengthwise.

5. The x-ray device as claimed in claim 1, wherein the positioning of the at least one first arm and the first x-ray component and the at least one second arm and the second x-ray component are controllable by a control unit.

6. The x-ray device as claimed in claim 2, wherein the first x-ray component and the second x-ray component are anchored in the ring structure by a locking apparatus.

7. The x-ray device as claimed in claim 2, wherein the at least one first arm and the at least one second arm are configured to be adjustable lengthwise.

8. The x-ray device as claimed in claim 3, wherein the at least one first arm and the at least one second arm are configured to be adjustable lengthwise.

9. The x-ray device as claimed in claim 2, wherein the positioning of the at least one first arm and the first x-ray component and the at least one second arm and the second x-ray component are controllable by a control unit.

10. The x-ray device as claimed in claim 3, wherein the positioning of the at least one first arm and the first x-ray component and the at least one second arm and the second x-ray component are controllable by a control unit.

11. The x-ray device as claimed in claim 4, wherein the positioning of the at least one first arm and the first x-ray component and the at least one second arm and the second x-ray component are controllable by a control unit.
